(19) United States
(12) Patent Application Publication
(10) Pub. No.: US 2023/0306782 A1
(43) Pub. Date: Sep. 28, 2023

(54) METHOD AND SYSTEM FOR DETECTING ONLINE MEETING ENGAGEMENT

(71) Applicant: JPMorgan Chase Bank, N.A., New York, NY (US)

(72) Inventors: Shakti Simanta DALABEHERA, Bangalore (IN); Saquib AHMAD, Bengaluru (IN); Pallav Devang RAVAL, Bangalore (IN); Puneet SHARMA, Bangalore (IN); Siddarth KALYANKAR, Bangalore (IN)

(73) Assignee: JPMorgan Chase Bank, N.A., New York, NY (US)

(21) Appl. No.: 17/663,144

(22) Filed: May 12, 2022

(30) Foreign Application Priority Data
Mar. 24, 2022 (IN) 202211016569

(51) Int. Cl. G06V 40/16; G06Q 10/10

(52) U.S. Cl. CPC G06V 40/168; G06V 40/165; G06Q 10/1095

(57) ABSTRACT

A method and system for detecting whether a person is engaged in an online meeting are provided. The method includes: receiving a streaming input image of a face of the person; capturing, from the streaming input image, still images of the face of the person; extracting facial features from the still images; labeling each still image as being either engaged or not engaged; and determining, based on the labels, a score that indicates a level of engagement of the person with respect to the online meeting. The labeling is performed by applying an artificial intelligence (AI) algorithm to the still images and the facial features. The AI algorithm is then applied to images of other meeting participants in order to obtain a composite score that indicates a global level of engagement for the online meeting.

### CROSS-REFERENCE TO RELATED APPLICATIONS

This application claims priority benefit from Indian Application No. 202211016569, filed Mar. 24, 2022, which is hereby incorporated by reference in its entirety.

### BACKGROUND

### 1. Field of the Disclosure

This technology generally relates to methods and systems for detecting online meeting engagement, more particularly to methods and systems for using machine learning techniques to provide an online meeting engagement detection capability in real time.

### 2. Background Information

In the recent difficult times, and as a direct result of the covid-19 pandemic, many lives have shifted to virtual presence. Face to face interactions have largely been replaced by online meetings, and going out to restaurants has largely been replaced by home delivery. While online meetings or classes have pros and cons, monitoring them has been a challenge. In the pre-covid times, when the classes and meetings were face to face, it was relatively easy to determine whether or not the participants in the meeting or classroom were engaged by using visual and cognitive means. The teacher or the presenter could easily change the course of the discussion when the level interaction fell flat, for example, by making a joke or repeating an explanation.

Online meetings are the new normal. However, online meetings are quite different than in-person meetings. For example, as a result of the pervasiveness of online meetings, every participant's presence is effectively reduced to a relatively small on-screen window of approximately 400 pixels by 400 pixels. This new mode of interaction may give rise to a challenge to the presenter, as they may not be sure whether the participants are paying attention to them or are just scrolling through another tab in the background. This lack of feedback may deteriorate the quality of meeting or the class.

Accordingly, there is a need for a mechanism for improving an understanding of online meeting engagement and obtaining valuable insights therefrom, in order to help presenters analyze their presentation content and adjust their delivery mechanism in the future.

### SUMMARY

The present disclosure, through one or more of its various aspects, embodiments, and/or specific features or sub-components, provides, inter alia, various systems, servers, devices, methods, media, programs, and platforms for using machine learning techniques to provide an online meeting engagement detection capability in real time.

According to an aspect of the present disclosure, a method for detecting whether a person is engaged in an online meeting is provided. The method is implemented by at least one processor. The method includes: receiving, by the at least one processor, a streaming input image of a face of the person; capturing, from the streaming input image by the at least one processor, a plurality of still images of the face of the person; extracting, by the at least one processor from at least one still image from among the plurality of still images, at least one facial feature; labeling, by the at least one processor, each of the plurality of still images as being one from among engaged and not engaged; and determining, by the at least one processor based on a result of the labeling, a score that indicates a level of engagement of the person with respect to the online meeting.

The capturing of the plurality of still images may include periodically capturing each respective still image from the streaming input image at a predetermined interval.

The labeling may be performed by applying, to the plurality of still images and the extracted at least one facial feature, an artificial intelligence (AI) algorithm that implements a machine learning technique and is trained by using historical facial image data.

The result of the applying of the AI algorithm may include, for each still image from among the plurality of still images, one from among a zero (0) that indicates a deficiency with respect to a predetermined level of engagement and a one (1) that indicates a sufficiency with respect to the predetermined level of engagement.

The method may further include combining the result of the AI algorithm with results of the AI algorithm being applied to images of other meeting participants in order to obtain a composite score that indicates a global level of engagement for the online meeting.

The method may further include outputting, via a graphical user interface (GUI), a pictorial representation of the obtained composite score as a function of time.

The method may further include classifying each of the at least one facial feature based on a predetermined set of action units that relate to facial muscle movements.

The predetermined set of action units may include at least 64 action units.

The method may further include obtaining information that relates to an emotional state of the person based on a result of the classifying.

The emotional state of the person may be expressible as a numerical value within a range of between zero (0) and one (1.0) that relates to at least one emotion type from among anger, disgust, fear, happiness, sadness, surprise, and a neutral emotion.

According to another aspect of the present disclosure, a computing apparatus for detecting whether a person is engaged in an online meeting is provided. The computing apparatus includes a processor; a memory; a display; and a communication interface coupled to each of the processor, the memory, and the display. The processor is configured to: receive, via the communication interface, a streaming input image of a face of the person; capture, from the streaming input image by the at least one processor, a plurality of still images of the face of the person; extract, from at least one still image from among the plurality of still images, at least one facial feature; label each of the plurality of still images as being one from among engaged and not engaged; and determine, based on a result of the labeling, a score that indicates a level of engagement of the person with respect to the online meeting.

The processor may be further configured to periodically capture each respective still image from the streaming input image at a predetermined interval.

The processor may be further configured to perform the labeling by applying, to the plurality of still images and the extracted at least one facial feature, an artificial intelligence (AI) algorithm that implements a machine learning technique and is trained by using historical facial image data.

A result of the application of the AI algorithm may include, for each still image from among the plurality of still images, one from among a zero (0) that indicates a deficiency with respect to a predetermined level of engagement and a one (1) that indicates a sufficiency with respect to the predetermined level of engagement.

The processor may be further configured to combine the result of the AI algorithm with results of the AI algorithm being applied to images of other meeting participants in order to obtain a composite score that indicates a global level of engagement for the online meeting.

The processor may be further configured to cause the display to display, via a graphical user interface (GUI), a pictorial representation of the obtained composite score as a function of time.

The processor may be further configured to classify each of the at least one facial feature based on a predetermined set of action units that relate to facial muscle movements.

The predetermined set of action units may include at least 64 action units.

The processor may be further configured to obtain information that relates to an emotional state of the person based on a result of the classification.

The emotional state of the person may be expressible as a numerical value within a range of between zero (0) and one (1.0) that relates to at least one emotion type from among anger, disgust, fear, happiness, sadness, surprise, and a neutral emotion.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates an exemplary computer system.

FIG. 2 illustrates an exemplary diagram of a network environment.

FIG. 3 shows an exemplary system for implementing a method for using machine learning techniques to provide an online meeting engagement detection capability in real time.

FIG. 4 is a flowchart of an exemplary process for implementing a method for using machine learning techniques to provide an online meeting engagement detection capability in real time.

FIG. 5 is a flow diagram that illustrates various modules that are components of a system for using machine learning techniques to provide an online meeting engagement detection capability in real time, according to an exemplary embodiment.

FIG. 6 is a snapshot of a still image of a participant in an online meeting and an assigned label indicating whether or not the participant is engaged in the meeting, according to an exemplary embodiment.

FIG. 7 is a snapshot of a facial image with markings that correspond to facial features and a table that maps the facial features to action units, according to an exemplary embodiment.

FIG. 8 is a group of facial images with markings that correspond to face landmark points, according to an exemplary embodiment.

FIG. 9 is the snapshot of the facial image of FIG. 7 and a chart that illustrates information that corresponds to an emotional state of the facial image, according to an exemplary embodiment.

FIG. 10 is a pictorial representation of an exemplary process for implementing a method for using machine learning techniques to provide an online meeting engagement detection capability in real time, according to an exemplary embodiment.

### DETAILED DESCRIPTION

Through one or more of its various aspects, embodiments and/or specific features or sub-components of the present disclosure, are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

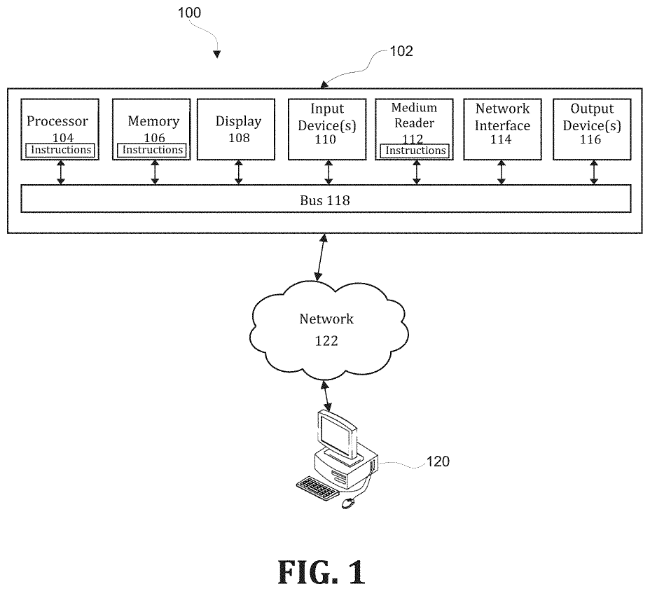

FIG. 1 is an exemplary system for use in accordance with the embodiments described herein. The system 100 is generally shown and may include a computer system 102, which is generally indicated.

The computer system 102 may include a set of instructions that can be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term “system” shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data as well as executable instructions and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions can be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, blu-ray disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid state display, a cathode ray tube (CRT), a plasma display, or any other type of display, examples of which are well known to skilled persons.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a global positioning system (GPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g. software, from any of the memories described herein. The instructions, when executed by a processor, can be used to perform one or more of the methods and processes as described herein. In a particular embodiment, the instructions may reside completely, or at least partially, within the memory 106, the medium reader 112, and/or the processor 110 during execution by the computer system 102.

Furthermore, the computer system 102 may include any additional devices, components, parts, peripherals, hardware, software or any combination thereof which are commonly known and understood as being included with or within a computer system, such as, but not limited to, a network interface 114 and an output device 116. The output device 116 may be, but is not limited to, a speaker, an audio out, a video out, a remote-control output, a printer, or any combination thereof.

Each of the components of the computer system 102 may be interconnected and communicate via a bus 118 or other communication link. As illustrated in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, Bluetooth, Zigbee, infrared, near field communication, ultraband, or any combination thereof. Those skilled in the art appreciate that additional networks 122 which are known and understood may additionally or alternatively be used and that the exemplary networks 122 are not limiting or exhaustive. Also, while the network 122 is illustrated in FIG. 1 as a wireless network, those skilled in the art appreciate that the network 122 may also be a wired network.

The additional computer device 120 is illustrated in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In accordance with various embodiments of the present disclosure, the methods described herein may be implemented using a hardware computer system that executes software programs. Further, in an exemplary, non-limited embodiment, implementations can include distributed processing, component/object distributed processing, and parallel processing. Virtual computer system processing can be constructed to implement one or more of the methods or functionalities as described herein, and a processor described herein may be used to support a virtual processing environment.

As described herein, various embodiments provide optimized methods and systems for using machine learning techniques to provide an online meeting engagement detection capability in real time.

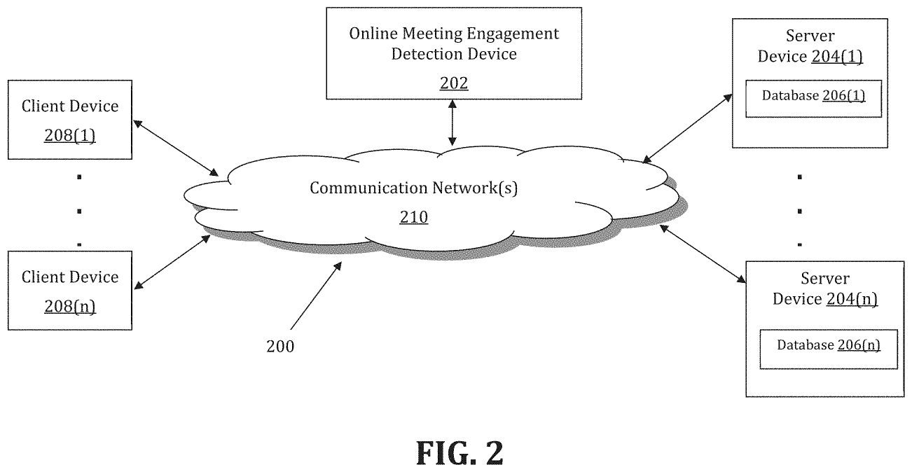

Referring to FIG. 2, a schematic of an exemplary network environment 200 for implementing a method for using machine learning techniques to provide an online meeting engagement detection capability in real time is illustrated. In an exemplary embodiment, the method is executable on any networked computer platform, such as, for example, a personal computer (PC).

The method for using machine learning techniques to provide an online meeting engagement detection capability in real time may be implemented by an Online Meeting Engagement Detection (OMED) device 202. The OMED device 202 may be the same or similar to the computer system 102 as described with respect to FIG. 1. The OMED device 202 may store one or more applications that can include executable instructions that, when executed by the OMED device 202, cause the OMED device 202 to perform actions, such as to transmit, receive, or otherwise process network messages, for example, and to perform other actions described and illustrated below with reference to the figures. The application(s) may be implemented as modules or components of other applications. Further, the application(s) can be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the OMED device 202 itself, may be located in virtual server(s) running in a cloud-based computing environment rather than being tied to one or more specific physical network computing devices. Also, the application(s) may be running in one or more virtual machines (VMs) executing on the OMED device 202. Additionally, in one or more embodiments of this technology, virtual machine(s) running on the OMED device 202 may be managed or supervised by a hypervisor.

In the network environment 200 of FIG. 2, the OMED device 202 is coupled to a plurality of server devices 204(1)-204(n) that hosts a plurality of databases 206(1)-206(n), and also to a plurality of client devices 208(1)-208(n) via communication network(s) 210. A communication interface of the OMED device 202, such as the network interface 114 of the computer system 102 of FIG. 1, operatively couples and communicates between the OMED device 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the OMED device 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein. This technology provides a number of advantages including methods, non-transitory computer readable media, and OMED devices that efficiently implement a method for using machine learning techniques to provide an online meeting engagement detection capability in real time.

By way of example only, the communication network(s) 210 may include local area network(s) (LAN(s)) or wide area network(s) (WAN(s)), and can use TCP/IP over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

The OMED device 202 may be a standalone device or integrated with one or more other devices or apparatuses, such as one or more of the server devices 204(1)-204(n), for example. In one particular example, the OMED device 202 may include or be hosted by one of the server devices 204(1)-204(n), and other arrangements are also possible. Moreover, one or more of the devices of the OMED device 202 may be in a same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the OMED device 202 via the communication network(s) 210 according to the HTTP-based and/or JavaScript Object Notation (JSON) protocol, for example, although other protocols may also be used.

The server devices 204(1)-204(n) may be hardware or software or may represent a system with multiple servers in a pool, which may include internal or external networks. The server devices 204(1)-204(n) hosts the databases 206(1)-206(n) that are configured to store facial expression image data and data that meeting-specific metrics and statistics.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a master/slave approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. For example, the client devices 208(1)-208(n) in this example may include any type of computing device that can interact with the OMED device 202 via communication network(s) 210. Accordingly, the client devices 208(1)-208(n) may be mobile computing devices, desktop computing devices, laptop computing devices, tablet computing devices, virtual machines (including cloud-based computers), or the like, that host chat, e-mail, or voice-to-text applications, for example. In an exemplary embodiment, at least one client device 208 is a wireless mobile communication device, i.e., a smart phone.

The client devices 208(1)-208(n) may run interface applications, such as standard web browsers or standalone client applications, which may provide an interface to communicate with the OMED device 202 via the communication network(s) 210 in order to communicate user requests and information. The client devices 208(1)-208(n) may further include, among other features, a display device, such as a display screen or touchscreen, and/or an input device, such as a keyboard, for example.

Although the exemplary network environment 200 with the OMED device 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as will be appreciated by those skilled in the relevant art(s).

One or more of the devices depicted in the network environment 200, such as the OMED device 202, the server devices 204(1)-204(n), or the client devices 208(1)-208(n), for example, may be configured to operate as virtual instances on the same physical machine. In other words, one or more of the OMED device 202, the server devices 204(1)-204(n), or the client devices 208(1)-208(n) may operate on the same physical device rather than as separate devices communicating through communication network(s) 210. Additionally, there may be more or fewer OMED devices 202, server devices 204(1)-204(n), or client devices 208(1)-208(n) than illustrated in FIG. 2.

In addition, two or more computing systems or devices may be substituted for any one of the systems or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

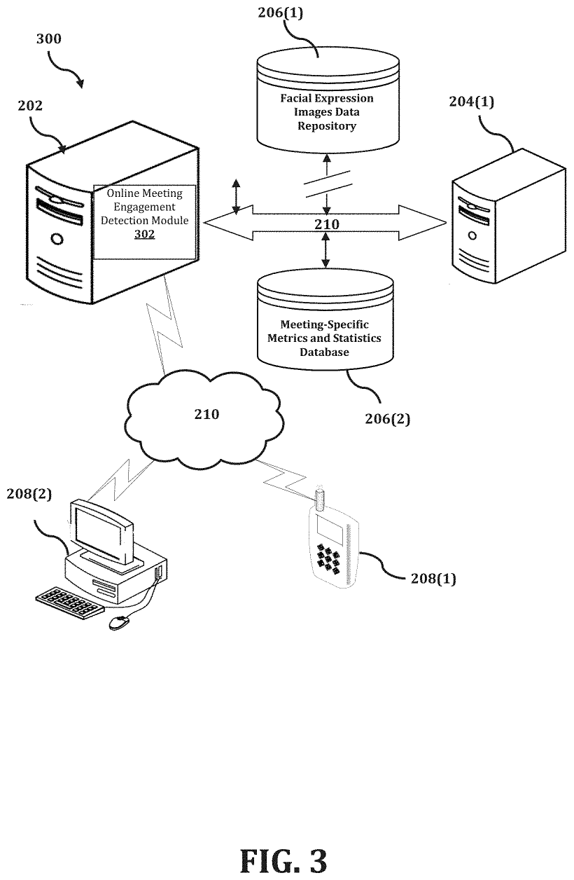

The OMED device 202 is described and illustrated in FIG. 3 as including online meeting engagement detection module 302, although it may include other rules, policies, modules, databases, or applications, for example. As will be described below, the online meeting engagement detection module 302 is configured to implement a method for using machine learning techniques to provide an online meeting engagement detection capability in real time.

An exemplary process 300 for implementing a mechanism for using machine learning techniques to provide an online meeting engagement detection capability in real time by utilizing the network environment of FIG. 2 is illustrated as being executed in FIG. 3. Specifically, a first client device 208(1) and a second client device 208(2) are illustrated as being in communication with OMED device 202. In this regard, the first client device 208(1) and the second client device 208(2) may be “clients” of the OMED device 202 and are described herein as such. Nevertheless, it is to be known and understood that the first client device 208(1) and/or the second client device 208(2) need not necessarily be “clients” of the OMED device 202, or any entity described in association therewith herein. Any additional or alternative relationship may exist between either or both of the first client device 208(1) and the second client device 208(2) and the OMED device 202, or no relationship may exist.

Further, OMED device 202 is illustrated as being able to access a facial expression images data repository 206(1) and a meeting-specific metrics and statistics database 206(2). The online meeting engagement detection module 302 may be configured to access these databases for implementing a method for using machine learning techniques to provide an online meeting engagement detection capability in real time.

The first client device 208(1) may be, for example, a smart phone. Of course, the first client device 208(1) may be any additional device described herein. The second client device 208(2) may be, for example, a personal computer (PC). Of course, the second client device 208(2) may also be any additional device described herein.

The process may be executed via the communication network(s) 210, which may comprise plural networks as described above. For example, in an exemplary embodiment, either or both of the first client device 208(1) and the second client device 208(2) may communicate with the OMED device 202 via broadband or cellular communication. Of course, these embodiments are merely exemplary and are not limiting or exhaustive.

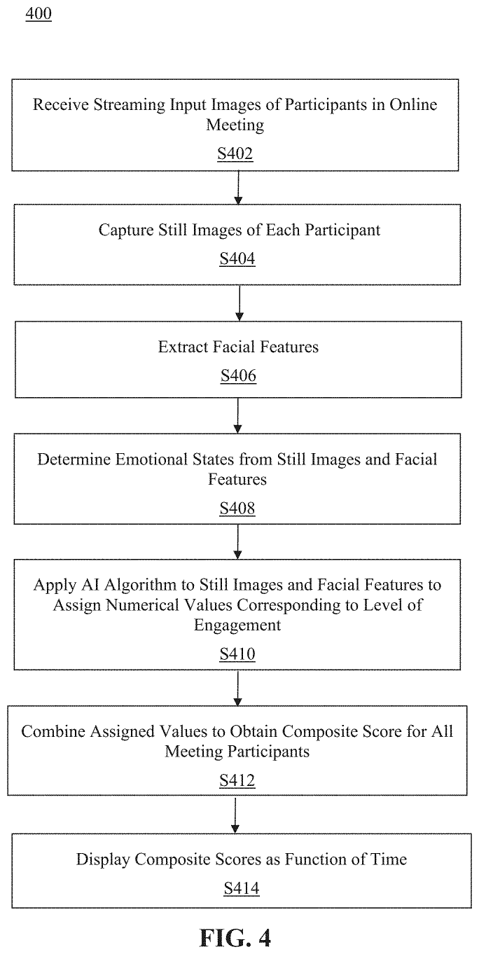

Upon being started, the online meeting engagement detection module 302 executes a process for using machine learning techniques to provide an online meeting engagement detection capability in real time. An exemplary process for using machine learning techniques to provide an online meeting engagement detection capability in real time is generally indicated at flowchart 400 in FIG. 4.

In process 400 of FIG. 4, at step S402, the online meeting engagement detection module 302 receives streaming input images of participants in an online meeting. In an exemplary embodiment, when an online meeting is conducted, there may be a number of participants, and for each participant, there may be a separate streaming image in which a face of the participant is visible.

At step S404, the online meeting engagement detection module 302 captures still images of each respective participant from the corresponding streaming images. In an exemplary embodiment, the still images may be captured periodically at a predetermined interval, such as, for example, every 5 seconds, every 10 seconds, every 30 seconds, every 60 seconds, every 5 minutes, or any other suitable interval.

At step S402, the online meeting engagement detection module 302 extracts facial features from the still images. In an exemplary embodiment, the facial features may correspond to action units, which are facial muscle movements represented by an individual muscle or a group of muscles. The action units may include a standard set of 64 action units by which each and every facial expression may be represented by a combination thereof. In an exemplary embodiment, the facial features may also correspond to face landmark points that are associated with respective portions of a face, such as eyelids, nose, chin, lips, cheeks, and/or any other portions of a human face.

At step S408, the online meeting engagement detection module 302 uses the still images and the extracted facial features to determine a respective emotional state of each meeting participant at a particular time. In an exemplary embodiment, the emotional states may be expressible as a numerical value between zero (0) and one (i.e., 1.0) and may relate to one or more emotional types from among the following set of emotions: anger, disgust, fear, happiness, sadness, surprise, and a neutral emotion.

At step S410, the online meeting engagement detection module 302 assigns numerical values that correspond to respective levels of engagement of each participant at a particular time. In an exemplary embodiment, the numerical values are assigned by applying an artificial intelligence (AI) algorithm to the still images and the extracted facial features. The AI algorithm implements a machine learning technique and is trained by using historical facial image data. In an exemplary embodiment, for each still image, the AI algorithm generates an output that includes either a zero (0) that indicates a deficiency with respect to a predetermined threshold level of engagement or a one (1) that indicates a sufficiency with respect to the threshold level of engagement.

At step S412, the online meeting engagement detection module 302 combines the assigned values in order to obtain a composite score that indicates a global level of engagement for all meeting participants at a particular time. In an exemplary embodiment, the composite score may be calculated by adding together all of the zeros and ones for still images that are captured at a first particular time, and then dividing the sum by the number of participants, in order to obtain a composite score that falls in the range between 0.0 and 1.0.

Then, the composite score may be calculated by adding together all of the zeros and ones for still images that are captured at a second particular time, and again dividing the sum by the number of participants. The calculation of the composite score may be repeated at each particular time that corresponds to the periodic interval at which the still images are captured, thus resulting in a sequence of composite scores. At step S414, the online meeting engagement detection module 302 may output the sequence of composite scores via a graphical user interface (GUI). For example, the sequence of composite scores may be displayed as a graph that shows a pictorial representation of the scores as a function of time. When such a graph is displayed to a presenter at the online meeting, the presenter may be able to observe whether the meeting participants are relatively engaged or not engaged in the meeting, and may then be able to adjust the presentation so as to improve the quality of the meeting.

In an exemplary embodiment, a method and a system for using machine learning techniques to provide an online meeting engagement detection capability in real time are disclosed. A goal is to build a framework to provide near-real-time/post-meeting feedback to a presenter with respect to overall engagement of an audience in an online conference using machine learning. This capability entails attempting to understand human facial expressions and body postures of an audience and predicting an overall engagement score of the audience at an aggregate level.

The aggregate engagement score is displayable to the presenter on a near-real-time basis while the meeting is ongoing in order to facilitate an opportunity to take appropriate action. For example, a presenter may decide to change the course of the discussion or skip certain content if a decrease in engagement score is observed. After the meeting has concluded, the presenter may tie back the most engaging and least engaging moments in the presentation and take appropriate corrective action for the next presentation. The same framework may be used for large recorded town hall meetings in order to determine an overall engagement level of the audience, without a need to obtain explicit feedback from the audience.

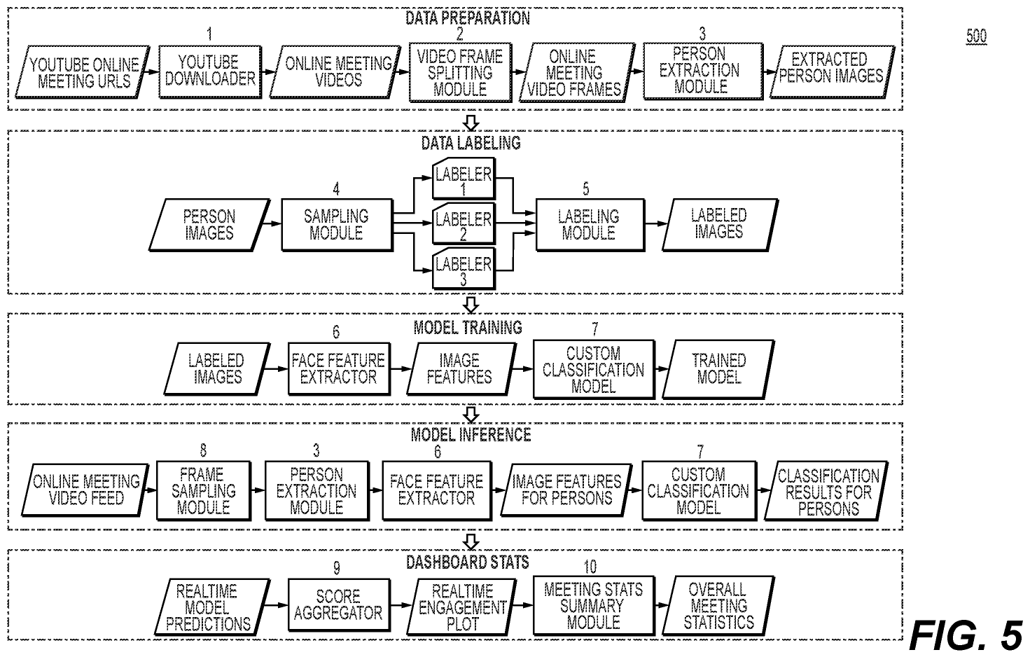

FIG. 5 is a flow diagram 500 that illustrates various modules that are components of a system for using machine learning techniques to provide an online meeting engagement detection capability in real time, according to an exemplary embodiment. In an exemplary embodiment, and as illustrated in the flow diagram 500, a system for using machine learning techniques to provide an online meeting engagement detection capability in real time may include a data preparation stage, a data labeling stage, a model training stage, a model inference stage, and a dashboard statistics stage.

Referring to FIG. 5, the data preparation stage may include a YouTube downloader module, a video frame splitting module, and a person extraction module. YouTube Downloader: In an exemplary embodiment, a set of YouTube videos with Creative Commons License are used to train a machine learning model for the AI application. This module is implemented for downloading YouTube videos from the Internet. In an exemplary embodiment, this module is a wrapper on a standard YouTube downloading library.

Video Frame Splitting Module: In an exemplary embodiment, this module converts video files to images that are consumed by a Deep Learning Computer Vision model. The module provides the functionality of reading a video file and extracting video frames as JPG images at provided timestamps. The module ensures that metadata, such as a YouTube video identification or Timestamp information, for each extracted video frame is recorded against stored JPG images.

Person Extraction Module: An online meeting snapshot may have multiple participants. The person extraction module separates each person in the image into different person images. In an exemplary embodiment, the module performs a Computer Vision Image Segmentation task, and provides bounding boxes for each identified person in the image. In an exemplary embodiment, the module is built on a Python library known as PixelLib, which uses a PointRend ResNet50 deep learning model.

Referring again to FIG. 5, the data labeling stage may include a sampling module and a labeling module. Sampling Module: The sampling module is implemented to assign extracted person images to a pool of labelers. This module samples images from different video sources which are later consumed by the labelers. In an exemplary embodiment, the sampling module is a custom module developed to reduce noise in the labeling process.

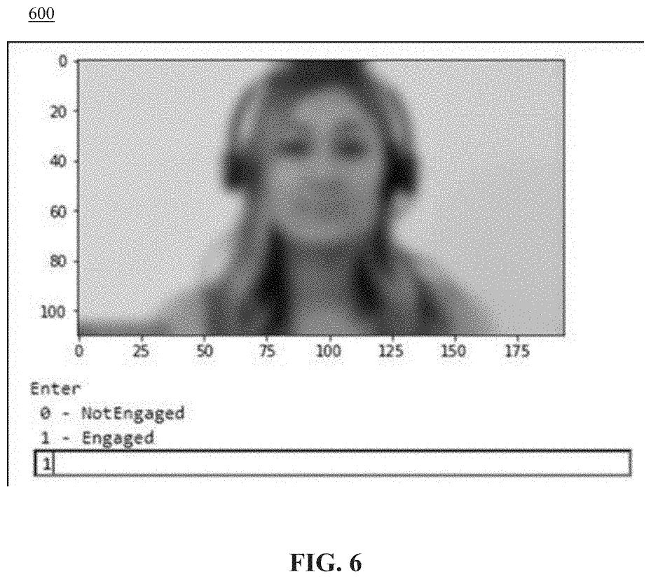

Labeling Module: The labeling module is designed to expedite labeling of extracted person images. In an exemplary embodiment, the labeling module is deployed on a JupyterLab server notebook and shared to the pool of labelers. The module is robust, fault tolerant and preserves labeling workflow states. FIG. 6 is a snapshot 600 of a still image of a participant in an online meeting and an assigned label indicating whether or not the participant is engaged in the meeting, according to an exemplary embodiment.

Referring again to FIG. 5, the model training stage and/or the model inference stage may include a face feature extractor module, a custom classification model module, and a frame sampling module. Face Feature Extractor: This module is a deep learning solution for extracting features from a person image. In an exemplary embodiment, the face feature extractor module is based on a deep learning library PyFeat.

In an exemplary embodiment, the extracted features may be grouped into action units. Action units are defined as facial muscle movement represented by an individual muscle or a group of muscles. In an exemplary embodiment, there are 64 standard action units or muscles associated with the face. Each and every facial expression can be represented by a combination of these action units.

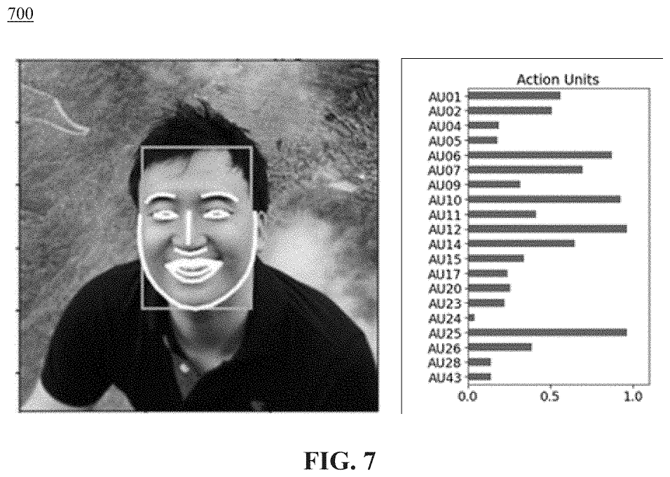

A random forest model may be used to determine a respective combination of standard action units for each feature. FIG. 7 is a snapshot 700 of a facial image with markings that correspond to facial features and a table that maps the facial features to action units, according to an exemplary embodiment.

In an exemplary embodiment, the extracted features may be grouped into face features. A challenge in detecting engagement in online meetings is the input image. In typical computer vision problems, the face is always pointing toward the camera; but in online meetings, the camera angle and distance often varies from one person to the other, and therefore it is necessary to isolate the face from the meeting image. The deep learning model RetinaFace has five (5) face features, including the following: 1) face x-coordinate; 2) face y-coordinate; 3) face width; 4) face height; and 5) face score. Using these features, the geometry of the face may be isolated and calculated.

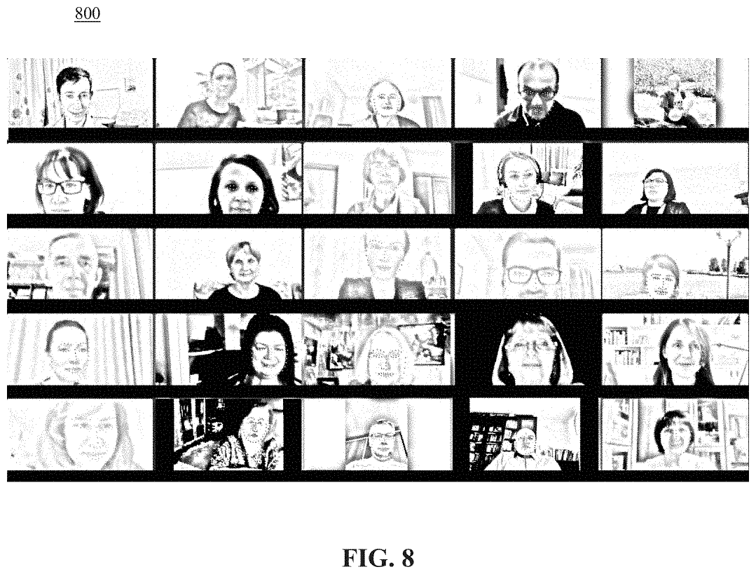

In an exemplary embodiment, the extracted features may be grouped into face landmark points. Facial landmarks, as the phrase suggests, are the coordinates of key landmarks on the face, such as, for example, eyelids, nose, chin, lips, cheeks, and/or any other portion of the face. Facial landmarks have at least two features in the form of x and y coordinates which are relative to the image scale. Facial landmarks are important to determining a level of engagement. In an exemplary embodiment, facial landmark features may be extracted from the image by using the deep learning mobilenet model from the PyFeat Library. FIG. 8 is a group of facial images 800 with markings that correspond to face landmark points, according to an exemplary embodiment.

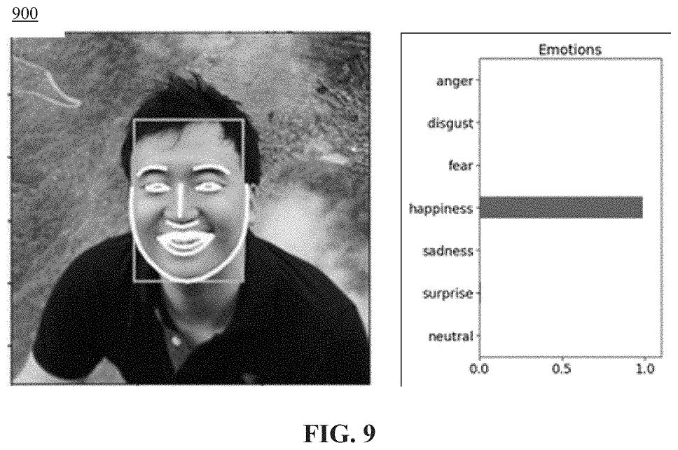

Emotion Features: An emotion feature is a derivative feature. Emotion states may be derived by using any of the primary features, such as action units or facial landmarks. Information that relates to an emotional state is quite vital for the determination of engagement. In an exemplary embodiment, facial emotion information may be extracted by using ResMaskNet or the residual masking network model. The model returns seven (7) features which correspond to seven different emotions from the image, including 1) anger; 2) disgust; 3) fear; 4) happiness; 5) sadness; 6) surprise; and 7) a neutral emotion. FIG. 9 is the snapshot 900 of the facial image of FIG. 7 and a chart that illustrates information that corresponds to an emotional state of the facial image, according to an exemplary embodiment.

Custom Classification Model Module: This module receives numerical data relating to individual face features from the Face Feature Extractor module and label data from the labeling module. In an exemplary embodiment, the data is divided into a training set, a validation set, and a test set using a Python Machine learning module known as scikit-learn. An XGBoost model is trained on the training dataset. Its hyperparameters are tuned using the validation dataset. The final accuracy is reported on the test data set. The model trained in this module predicts binary classes, including an “Engaged” class and a “NotEngaged” class, for each person image feature.

Frame Sampling Module: The frame sampling module samples video frame from a live meeting feed at predetermined intervals. In an exemplary embodiment, the output of the frame sampling module is consumed by Deep Learning and Custom ML models for prediction. The frame sampling module allows for tunable sampling rates. The sampling rate will determine the rate at which meeting metrics are refreshed on a graphical user interface (GUI) dashboard.

Referring again to FIG. 5, the dashboard statistics stage may include a score aggregator module and a meeting statistics summary module. Score Aggregator: The score aggregator module aggregates the classification scores for individual persons and calculates aggregate statistics. The module receives individual engagement predictions for each identified person. An average engagement score is calculated by dividing a number of identified engaged persons by a total number of identified persons. A final score is calculated as a percentage, and the score aggregator module transmits this value as a meeting engagement score.

Meeting Statistics Summary Module: The meeting statistics summary module displays real-time meeting statistics on a dashboard for a presenter. In an exemplary embodiment, a chart with an aggregate meeting engagement score plotted against time is displayed. This plot is updated in real time. At the end of the session, the online meeting is summarized by using the following metrics: 1) total duration of the meeting; 2) average number of persons in the meeting; 3) an overall engagement score; 4) time durations for the most engaging parts of meeting; 5) time durations for the least engaging parts of meeting; and 6) a chart displaying a number of persons and engagement score for each quintile of meeting duration. In an exemplary embodiment, the presenter may obtain a live feedback of the meeting in order to facilitate corrective actions.

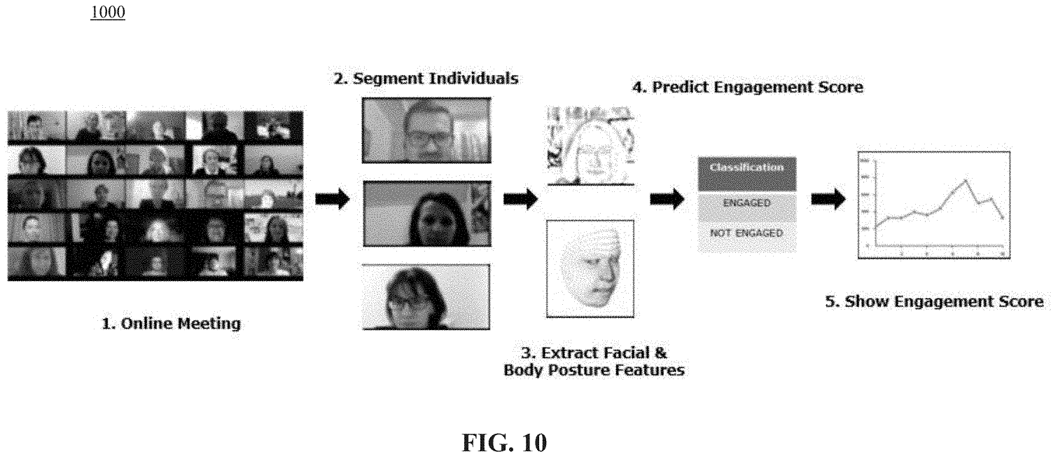

FIG. 10 is a pictorial representation 1000 of a process for implementing a method for using machine learning techniques to provide an online meeting engagement detection capability in real time, according to an exemplary embodiment. As illustrated in FIG. 10, the process includes the following operations: 1) An online meeting is conducted; 2) individual participants are segmented into respective images of the faces of each participant; 3) facial and body posture features are extracted from the images; 4) an engagement score is predicted; and 5) individual engagement scores and a composite engagement score is determined, and a graphical representation of a sequence of composite engagement scores as a function of time is displayed.

Accordingly, with this technology, an optimized process for using machine learning techniques to provide an online meeting engagement detection capability in real time is provided.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims, and their equivalents, and shall not be restricted or limited by the foregoing detailed description.

1. A method for detecting whether a person is engaged in an online meeting, the method being implemented by at least one processor, the method comprising:
receiving, by the at least one processor, a streaming input image of a face of the person;
capturing, from the streaming input image by the at least one processor; a plurality of still images of the face of the person;
extracting, by the at least one processor from at least one still image from among the plurality of still images, at least one facial feature;
labeling, by the at least one processor, each of the plurality of still images as being one from among engaged and not engaged; and
determining, by the at least one processor based on a result of the labeling, a score that indicates a level of engagement of the person with respect to the online meeting.

2. The method of claim 1, wherein the capturing of the plurality of still images comprises periodically capturing each respective still image from the streaming input image at a predetermined interval.

3. The method of claim 1, wherein the labeling comprises applying, to the plurality of still images and the extracted at least one facial feature, an artificial intelligence (AI) algorithm that implements a machine learning technique and is trained by using historical facial image data.

4. The method of claim 3, wherein a result of the applying of AI algorithm includes, for each still image from among the plurality of still images, one from among a zero (0) that indicates a deficiency with respect to a predetermined level of engagement and a one (1) that indicates a sufficiency with respect to the predetermined level of engagement.

5. The method of claim 4, further comprising combining the result of the AI algorithm with results of the AI algorithm being applied to images of other meeting participants in order to obtain a composite score that indicates a global level of engagement for the online meeting.

6. The method of claim 5, further comprising outputting, via a graphical user interface (GUI), a pictorial representation of the obtained composite score as a function of time.

7. The method of claim 1, further comprising classifying each of the at least one facial feature based on a predetermined set of action units that relate to facial muscle movements.

8. The method of claim 7, wherein the predetermined set of action units comprises at east 64 action units.

9. The method of claim 7, further comprising obtaining information that relates to an emotional state of the person based on a result of the classifying.

10. The method of claim 9, wherein the emotional state of the person is expressible as a numerical value within a range of between zero (0) and one (1.0) that relates to at least one emotion type from among anger, disgust, fear, happiness, sadness, surprise, and a neutral emotion.

11. A computing apparatus for detecting whether a person is engaged in an online meeting, the computing apparatus comprising:
a processor;
a memory;
a display; and
a communication interface coupled to each of the processor, the memory, and the display, wherein the processor is configured to:
receive, via the communication interface, a streaming input image of a face of the person;
capture, from the streaming input image by the at least one processor, a plurality of still images of the face of the person;
extract, from at least one still image from among the plurality of still images; at least one facial feature;
label each of the plurality of still ages as being one from among engaged and not engaged; and
determine, based on a result of the labeling, a score that indicates a level of engagement of the person with respect to the online meeting.

12. The computing apparatus of claim 11, wherein the processor is further configured to periodically capture each respective still image from the streaming input image at a predetermined interval.

13. The computing apparatus of claim 11, wherein the processor is further configured to perform the labeling by applying, to the plurality of still images and the extracted at least one facial feature, an artificial intelligence (AI) algorithm that implements a machine learning technique and is trained by using historical facial image data.

14. The computing apparatus of claim 13, wherein a result of the application of the AI algorithm includes, for each still image from among the plurality of still images, one from among a zero (0) that indicates a deficiency with respect to a predetermined level of engagement and a one (1) that indicates a sufficiency with respect to the predetermined level of engagement.

15. The computing apparatus of claim 14, wherein the processor is further configured to combine the result of the AI algorithm with results of the AI algorithm being applied to images of other meeting participants in order to obtain a composite score that indicates a global level of engagement for the online meeting.

16. The computing apparatus of claim 15, wherein the processor is further configured to cause the display to display, via a graphical user interface (GUI), a pictorial representation of the obtained composite score as a function of time.

17. The computing apparatus of claim 11, wherein the processor is further configured to classify each of the at least one facial feature based on a predetermined set of action units that relate to facial muscle movements.

18. The computing apparatus of claim 17, wherein the predetermined set of action units comprises at least 64 action units.

19. The computing apparatus of claim 17, wherein the processor is further configured to obtain information that relates to an emotional state of the person based on a result of the classification.

20. The computing apparatus of claim 19, wherein the emotional state of the person is expressible as a numerical value within a range of between zero (0) and one (1.0) that relates to at least one emotion type from among anger, disgust, fear, happiness, sadness, surprise, and a neutral emotion.
